(19) United States
(12) Patent Application Publication
(10) Pub. No.: US 2008/0150374 A1
(43) Pub. Date: Jun. 26, 2008

(54) COIL ARRANGEMENT FOR SHAFT-TYPE LINEAR MOTOR

(76) Inventors: CHIA-MING CHANG, Taichung (TW); Fang-Fang Tai, Taichung (TW); Chih-Yu Wang, Taichung (TW)

Correspondence Address: Dr. BANGER SHIA, 102 Lindencrest Ct., Sugar Land, TX, 77479-5201, US

(21) Appl. No.: 11/615,984

(22) Filed: Dec. 24, 2006

(51) Int. Cl. H02K 41/00

(52) U.S. Cl. 310/12

(57) ABSTRACT

A coil arrangement for a shaft-type linear motor is disposed in a mover and comprises a plurality of insulating members and a plurality of coils. Each of the insulating members is at least defined in the center thereof with a stator passage. The stator passage is surrounded by an insulating ring with a receiving surface. An insulating flange protrudes from a side edge of the receiving surface, and a positioning notch is defined in the insulating flange. By such arrangements simplify the coil winding operation, and solve the problem of the conduction of the stator, and the dust accumulation in the coil.

### BACKGROUND OF THE INVENTION

1. Field of the Invention

The present invention relates to a component for a shaft-type linear motor, and more particularly to a coil arrangement for a shaft-type linear motor, which can simplify the coil winding operation, and can solve the problem of the conduction of the stator, and the dust accumulation in the coil.

2. Description of the Prior Art

Nowadays, shaft-type linear motor is used more and more widely in modem industries, and the linear transmission device generally includes linear guideway and ball screw. In addition to the effect of high precision, the linear transmission device also has the advantages of low frictional loss, high energy conversion ratio, low noise and high rigidity. Hence, it is self-evident that the shaft-type linear motor is very important to various industrial mechanisms.

In order that the stator and the mover can operate smoothly, the current shaft-type linear motors are usually provided on the elongated stator thereof with different magnetic poles (the stator is in the form of a shaft), and then a mover with coils is mounted on the elongated stator, and the coils are used to move the mover along the stator based on the theory of the generation of magnetic force by electric power. However, the various existing designs have their own disadvantages. Therefore, how to develop an improved and competitive tape-sticking product is the common goal that the manufactures are striving for.

Examples of various conventional shaft-type axis motors are as shown in FIGS. 1, 2 and 3.

As shown in FIG. 1, firstly, a copper wire is wound into a coil 10, then the coil 10 is placed into the a spacer ring 11. In a side of the spacer ring 11 is formed a guiding notch 111 through which the wire of the coil 10 can extend out of the spacer ring 11, the coils 10 are separated from one another by the spacer ring 11 (for easy control), and then are inserted on an elongated shaft type stator (not shown). The coil 10 in the spacer ring 11 serves to move the mover based on the theory of the generation of magnetic force by electric power. The spacer ring 11 is mounted on the outer periphery of the coil 10 in order to maintain the shape of the coil 10. However, this conventional design has the following disadvantages:

First, it should use a tool to wind the copper wire into a coil 10, and then the coil 10 should be placed into the spacer ring 11, therefore, the assembly is complicated. Further, the full pitch windings of the coil 10 are difficult to be consistent with each other.

Second, there is no spacer between the coil 10 and the elongated shaft type stator, magnetic force will not be blocked, however, the electric arc and the dust will not be blocked either. Therefore, electric arc will be produced between the oil 10 and the stator (affect the effect of the magnetic force), and the coil 10 is likely to be contaminated by the dust accumulated in the work surrounding.

FIG. 2 shows another conventional mode. Similarly, copper wires are wound into coils 12, and then the coils 12 are placed into a plurality of spacer rings 13. The interval between the spacer rings 13 allowing the wire of the coils 12 to pass therethrough, the coils 12 are separated from one another by the spacer rings 13 (for easy control), and then are inserted on an elongated shaft type stator (not shown). The coils 12 in the spacer rings 13 serve to move the mover based on the theory of the generation of magnetic force by electric power. The spacer rings 13 are mounted on the outer periphery of the coils 12 in order to maintain the shape of the coils 12. However, this conventional design has the following disadvantages:

First, it should use a tool to wind the copper wires into coils 12, and then the coils 12 should be placed into the spacer rings 13, therefore, the assembly is complicated. Further, the full pitch windings of the coils 12 are difficult to be consistent with each other.

Second, there is no spacer between the coils 12 and the elongated shaft type stator, magnetic force will not be blocked, however, the electric arc and the dust will not be blocked either. Therefore, electric arc will be produced between the oils 12 and the stator (affect the effect of the magnetic force), and the coils 12 are likely to be contaminated by the dust accumulated in the work surrounding.

Third, when the coils 12 are piled up, it should be careful to prevent the spacer rings 13 from contacting each other, otherwise the stack of the coils 12 will be unstable. And this is time-consuming.

Finally, FIG. 3 shows a third conventional example. Similarly, copper wires are wound into coils 14, and then a side of the respective the coils 14 is fixed to a positioning member 15 which has an interval 151 for allowing the wire of the coils 14 to pass therethrough. After that, a plurality of positioning member 15 is positioned on a positioning board 16 to separate the coils 14 from one another (for easy control), and then is inserted on an elongated shaft type stator (not shown). However, this conventional design has the following disadvantages:

First, it should use a tool to wind the copper wires into coils 14; obviously, the assembly is troublesome. Further, the fall pitch windings of the coils 14 are difficult to be consistent with each other.

Second, the third conventional device cannot block the electric arc and the dust either. Therefore, electric arc will be produced between the oils 14 and the stator (affect the effect of the magnetic force), and the coils 14 are likely to be contaminated by the dust accumulated in the work surrounding.

To effectively solve the aforementioned problems, the inventor of the present invention, on the basis of the accumulated experience and skills associated with the linear transmission field, has developed a brand new coil arrangement for a shaft-type linear motor.

### SUMMARY OF THE INVENTION

The primary objective of the present invention is to provide a coil arrangement for a shaft-type linear motor, wherein the coils are orderly arranged and the winding operation is simplified.

The secondary objective of the present invention is to provide a coil arrangement for a shaft-type linear motor, which can solve the problem of the conduction of the stator, and the dust accumulation in the coil.

To obtain the abovementioned objectives, a coil arrangement for a shaft-type linear motor in accordance with the present invention is disposed in a mover and comprises a plurality of insulating members and a plurality of coils. Each of the insulating members is at least defined in the center thereof with a stator passage. The stator passage is surrounded by an insulating ring with a receiving surface. An insulating flange protrudes from a side edge of the receiving surface, and a positioning notch is defined in the insulating flange.

The insulating member itself serves as a tool for winding the wire into the coil, therefore, the present invention doesn't require the use of tool for winding the wire. Further, the insulating members can be piled up directly to form a coil arrangement, therefore, the coils are orderly arranged, and the assembly time is effectively reduced.

Further, when a stator is inserted in the stator passage of the respective insulating members, the insulating flange will prevent the occurrence of electric arc and the accumulation of dust.

### BRIEF DESCRIPTION OF THE DRAWINGS

FIG. 1 is an exploded view of showing a conventional coil arrangement for a shaft-type linear motor;

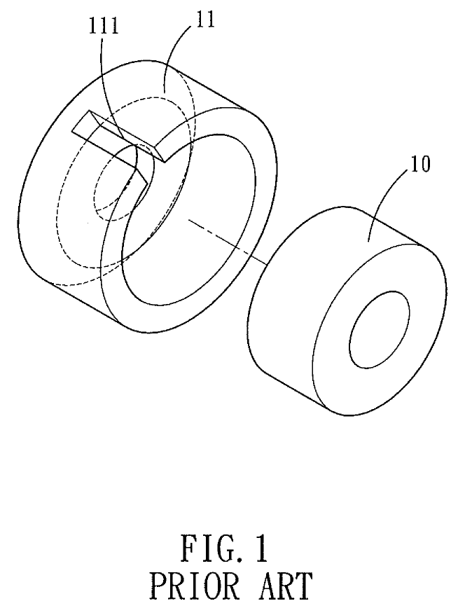

FIG. 2 is an exploded view of showing a second conventional coil arrangement for a shaft-type linear motor;

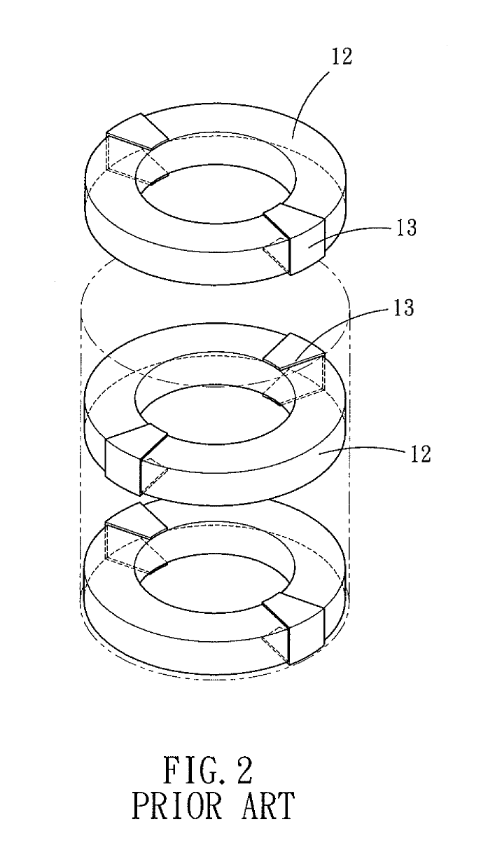

FIG. 3 is an exploded view of showing a third conventional coil arrangement for a shaft-type linear motor;

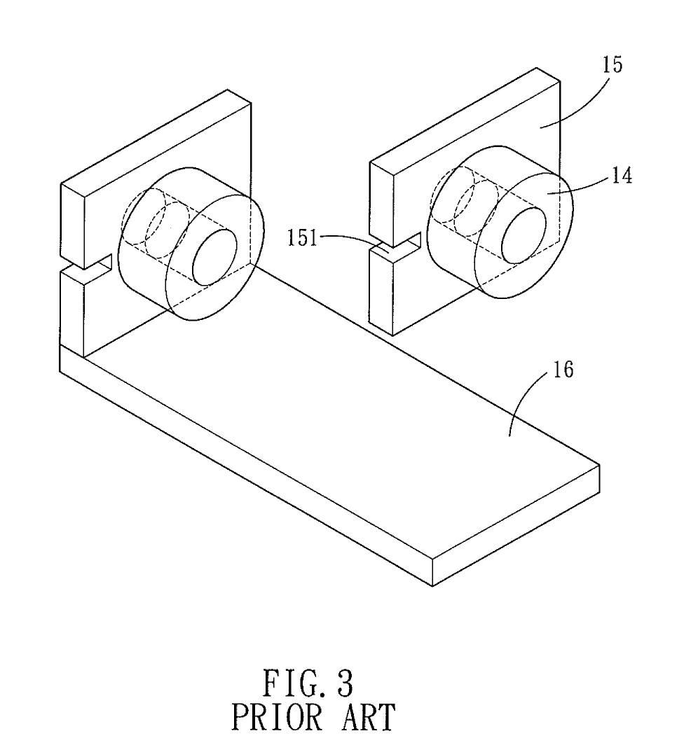

FIG. 4 is a perspective view of showing an insulating member without coil in accordance with the present invention;

FIG. 5 is a perspective view of showing an insulating member with a coil in accordance with the present invention;

FIG. 6 is an exploded view of a coil arrangement for a shaft-type linear motor in accordance with the present invention;

FIG. 7 is a cross sectional view of showing the coil arrangement for a shaft-type linear motor in accordance with the present invention;

FIG. 8 shows a second type of insulating member in accordance with the present invention;

FIG. 9 shows a third type of insulating member in accordance with the present invention; and

FIG. 10 shows a fourth type of insulating member in accordance with the present invention.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

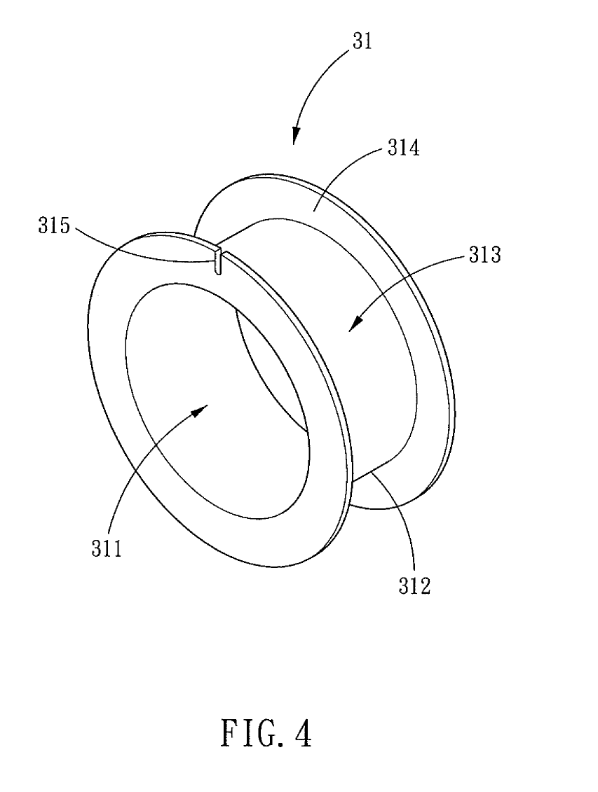

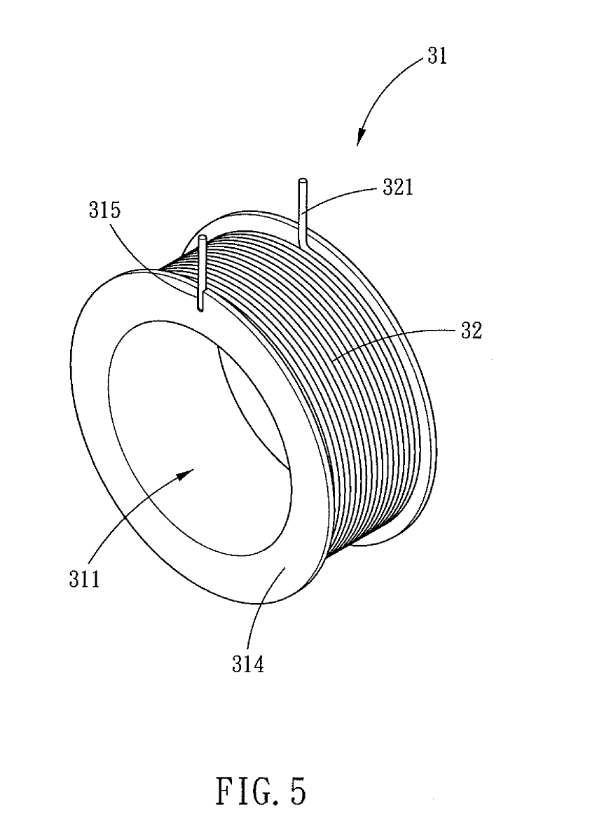

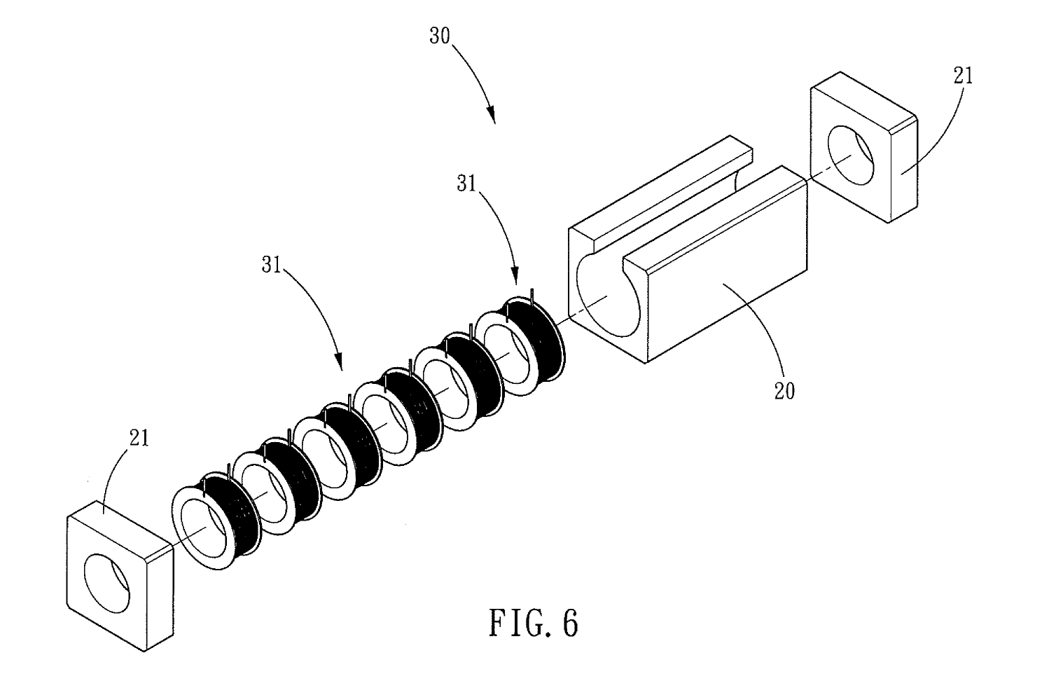

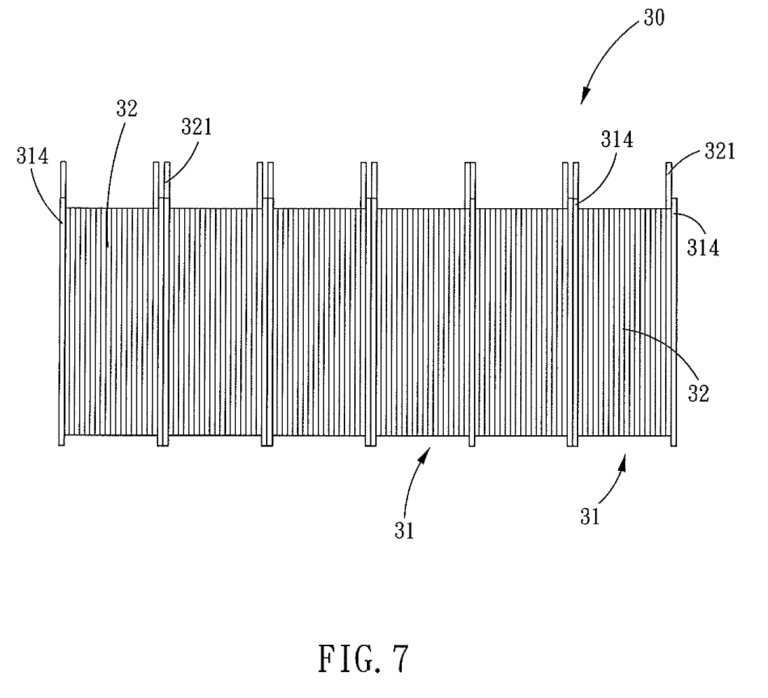

A first embodiment of the present invention is illustrated in FIGS. 4-7, please refer initially to FIG. 6. A coil arrangement 30 for a shaft-type linear motor of this embodiment is disposed in a mover 20 and the covers 21 and is located correspondingly to the stator (not shown).

The oil arrangement 30 comprises: a plurality of insulating members 31 and a plurality of coils 32. The insulating members 31 are placed against each other, and each of the insulating members 31 is provided with a coil 32.

The insulating members 31 are made of nonconductive material (such as; Teflon, high voltage resistant insulating paper). In the center of the respective insulating members 31 is formed a circular stator passage 311 which is surrounded by an insulating ring 312 with a receiving surface 313. Two insulating flanges 314 protrude from both side edges of the receiving surface 313, and each of the insulating flanges 314 is defined with at least one positioning notch 315.

The coils 32 wind about the receiving surface 313 of the respective insulating members 31 and are separated from one another by the insulating flanges 314 of the insulating members 31, and the terminals 321 of the respective coils 32 extend outward from the positioning notch 315.

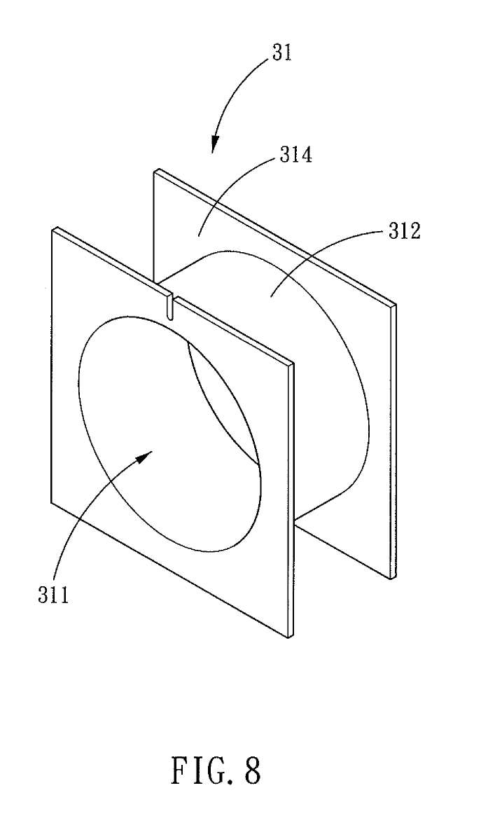

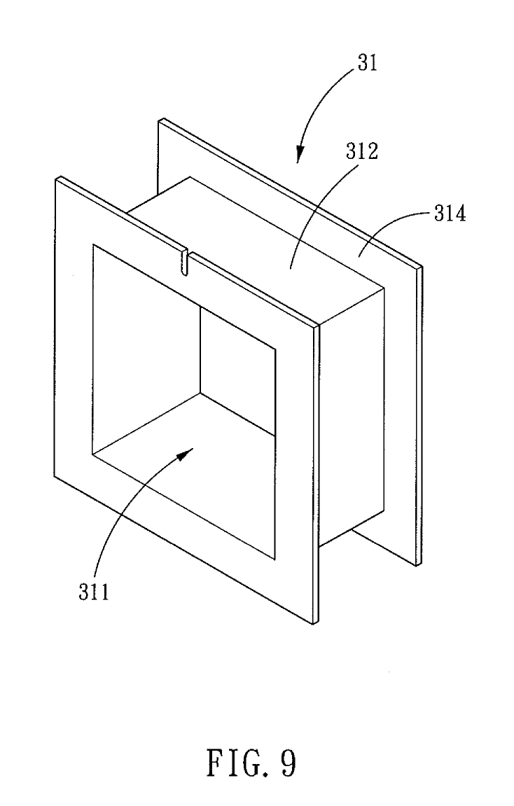

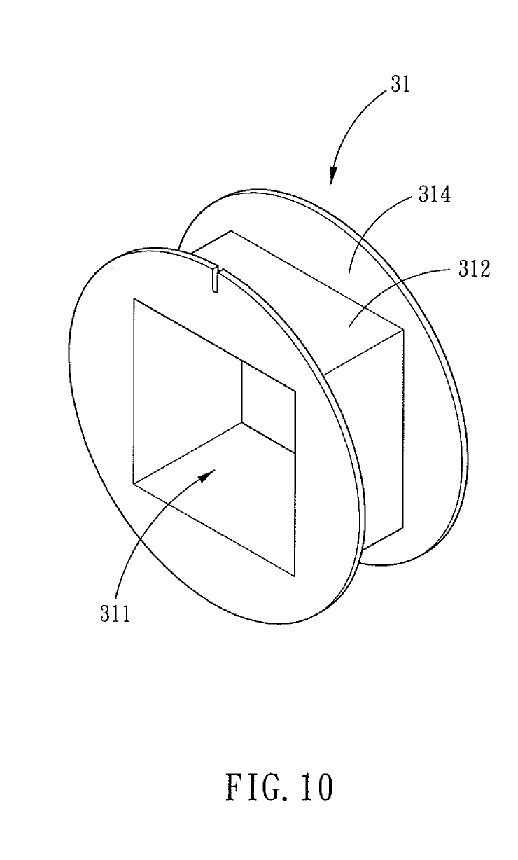

It is to be noted that, as shown in FIGS. 8, 9, and 10, the insulating member 31 includes various types, the stator passage 311 and the insulating ring 312 can be square or circular, and the insulating flanges 314 can also be square or circular. The various embodiments of the insulating member 31 as shown in FIGS. 8, 9 and 10 have the same technical characteristics.

For a better understanding of the embodiment, reference should be made to the following descriptions.

The coils 32 wind about the receiving surface 313 of the respective insulating members 31 and are separated from one another by the insulating flanges 314 of the insulating members 31, so that the respective coils 32 can operate independently. It is important that the insulating member 31 itself serves as a tool for winding the wire into the coil 32. Therefore, the present invention doesn't require the use of tool for winding the wire. Further, the insulating members 31 can be piled up directly to form a coil arrangement 30, and the size and the full pitch winding of the respective coils 31 are consistent with one another, effectively reducing the assembly time.

The stator passage 311 of the insulating members 31 is surrounded by the insulating ring 312 with the receiving surface 313, and the coil 32 winds about the receiving surface 313 of the insulating members 31. When a stator is inserted in the stator passage 311 of the respective insulating members 31, although the coils 32 produce magnetic force after being electrified, the insulating flange 312 will prevent the occurrence of electric arc and the accumulation of dust.

While we have shown and described various embodiments in accordance with the present invention, it is clear to those skilled in the art that further embodiments may be made without departing from the scope of the present invention.

What is claimed is:

1. A coil arrangement for a shaft-type linear motor being disposed in a mover and located correspondingly to a stator, comprising a plurality of insulating members being placed against one another, and each of the insulating members provided with a coil; wherein:
each of the insulating members is made of nonconductive material and is defined with a stator passage which is surrounded by an insulating ring with a receiving surface, an insulating flange protrudes from at least one side edge of the receiving surface, and at least one positioning notch is defined in the insulating flange; and
the coils wind about the receiving surface of the respective insulating members and are separated from one another by the insulating flange of the respective insulating members, the coils extend outward through the positioning notch of the respective insulating members.

2. The coil arrangement for a shaft-type linear motor as claimed in claim 1, wherein the insulating flange protrudes from both side edges of the receiving surface of the insulating members.

3. The coil arrangement for a shaft-type linear motor as claimed in claim 2, wherein the nonconductive material of the insulating members is Teflon, or high voltage resistant insulating paper.

4. The coil arrangement for a shaft-type linear motor as claimed in claim 3, wherein a circular stator passage is formed in a center of the respective insulating members.

5. The coil arrangement for a shaft-type linear motor as claimed in claim 3, wherein a square stator passage is formed in the center of the respective insulating members.

6. The coil arrangement for a shaft-type linear motor as claimed in claim 4, wherein the insulating flange of the respective insulating members is square or circular.

7. The coil arrangement for a shaft-type linear motor as claimed in claim 5, wherein the insulating flange of the respective insulating members is square or circular.
